(19) United States
(12) Patent Application Publication
(10) Pub. No.: US 2025/0157047 A1
(43) Pub. Date: May 15, 2025

(54) INFORMATION PROCESSING APPARATUS, INFORMATION PROCESSING METHOD AND PROGRAM

(71) Applicant: Renesas Electronics Corporation, Tokyo (JP)

(72) Inventors: Takayoshi KOMURO, Tokyo (JP); Koki NAGATA, Tokyo (JP)

(21) Appl. No.: 18/925,403

(22) Filed: Oct. 24, 2024

(30) Foreign Application Priority Data
Nov. 13, 2023 (JP) 2023-193147

(51) Int. Cl. G06T 7/20

(52) U.S. Cl. CPC G06T 7/20

(57) ABSTRACT

To appropriately estimate the amount and direction of movement of a moving object, an information processing apparatus has an acquisition unit that acquires each image captured at each point in time by a shooting device mounted on the moving object; a determination unit that determines the type of movement of the moving object based on the respective images; and an estimation unit that, based on a first image and a second image captured at a time interval corresponding to the type of movement from the first image, estimates the amount and direction of movement of the moving object from the first point in time when the first image was captured to the second point in time when the second image was captured.

### CROSS-REFERENCE TO RELATED APPLICATIONS

The disclosure of Japanese Patent Application No. 2023-193147 filed on Nov. 13, 2023, including the specification, drawings and abstract is incorporated herein by reference in its entirety.

### BACKGROUND

This disclosure relates to, for example, an information processing apparatus, an information processing method, and a program.

There are disclosed techniques listed below.
[Patent Document 1] Japanese Unexamined Patent Application Publication No. 2019-004329

Conventionally, a technique for calculating optical flow, which is a vector indicating the movement of feature points in temporally continuous time-series images, is known (see, for example, Patent Document 1).

### SUMMARY

However, Patent Document 1 does not consider using optical flow to estimate the position to which a shooting device has moved. Other objects and novel features will become apparent from the description of this specification and the accompanying drawings.

In one embodiment, an information processing apparatus is provided, including: an acquisition unit that acquires each image captured at each point in time by a shooting device mounted on a moving object; a determination unit that determines the type of movement of the moving object based on the respective images; and an estimation unit that estimates the amount and direction of movement of the moving object from the first point in time when the first image was captured to the second point in time when the second image was captured, based on the first image and the second image captured at a time interval corresponding to the type of movement.

According to the one embodiment, it is possible to appropriately estimate the amount and direction of movement of the moving object.

### BRIEF DESCRIPTION OF THE DRAWINGS

FIG. 1 is a block diagram showing an example of the configuration of a moving object according to an embodiment.

FIG. 2 is a block diagram showing an example of the configuration of an information processing apparatus according to an embodiment.

FIG. 3 is a block diagram showing an example of the hardware configuration of an information processing apparatus according to an embodiment.

FIG. 4 is a flowchart showing an example of the processing of an information processing apparatus according to an embodiment.

FIG. 5 is a diagram showing an example of optical flow according to an embodiment.

### DETAILED DESCRIPTION

This disclosure is described with reference to several exemplary embodiments. These embodiments are described for illustrative purposes only and without intending to limit the scope of this disclosure, it is understood that these embodiments help those skilled in the art to understand and implement this disclosure. The disclosures described in this specification can be implemented in various ways other than those described below.

In the following description and claims, unless otherwise defined, all technical and scientific terms used herein have the same meaning as commonly understood by one of ordinary skill in the art to which this disclosure belongs.

Hereinafter, embodiments of this disclosure will be described with reference to the drawings. Each drawing is merely illustrative for describing one or more embodiments. Each drawing is not limited to a single specific embodiment but may be related to one or more other embodiments. As will be understood by those skilled in the art, various features or steps described with reference to any one of the drawings can be combined with features or steps shown in one or more other drawings to create embodiments not explicitly illustrated or described. Not all features or steps shown in anyone drawing for describing exemplary embodiments are necessarily required, and some features or steps may be omitted. The order of steps described in any drawing may be changed as appropriate.

### (System Configuration)

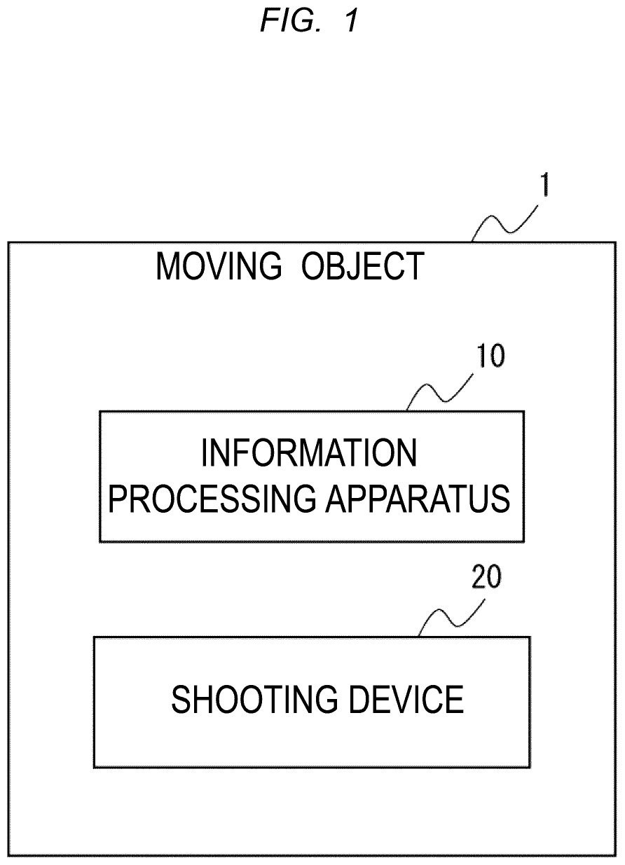

Referring to FIG. 1, the configuration of a moving object 1 according to an embodiment will be described. FIG. 1 is a diagram showing an example of the configuration of the moving object 1 according to the embodiment. In the example of FIG. 1, the moving object 1 includes an information processing apparatus 10 and a shooting device 20. In the example of FIG. 1, the information processing apparatus 10 and the shooting device 20 are connected so as to be able to communicate via a network N. The number of information processing apparatus 10 and shooting devices 20 is not limited to the example in FIG. 1.

Examples of network N include, for example, the Internet, mobile communication systems, wireless LAN (Local Area Network), LAN, and buses, etc. Examples of mobile communication systems include, for example, the 5th generation mobile communication system (5G), the 6th generation mobile communication system (6G, Beyond 5G), the 4th generation mobile communication system (4G), the 3rd generation mobile communication system (3G), etc.

The shooting device 20 is mounted on the moving object 1 and is an imaging device (camera, monocular camera) that captures images at each point in time. The shooting device 20 may be installed, for example, so that the direction of travel of the moving object 1 becomes the imaging range.

The information processing apparatus 10 is a device such as, for example, a microcomputer, an ECU (Electronic Control Unit), a server, a cloud server, etc. The information processing apparatus 10 estimates, for example, the amount of movement and direction of movement of the moving object 1 based on each image captured by the shooting device 20.

For example, the moving object 1 may be a vehicle that travels on roads, etc., by wheels, a railway vehicle that travels on tracks, a robot that moves on land by wheels or legs, an unmanned aerial vehicle (drone), an aircraft, and a ship, etc.

The moving object 1 may support the driver's (operator's) driving operation by the Advanced Driver-Assistance Systems (ADAS) based on the amount of movement and direction of movement estimated by the information processing apparatus 10. Furthermore, the moving object 1 may grasp its current position based on the amount of movement and direction of movement estimated by the information processing apparatus 10 and move (travel) automatically (autonomously).

### (Configuration of the Information Processing Apparatus)

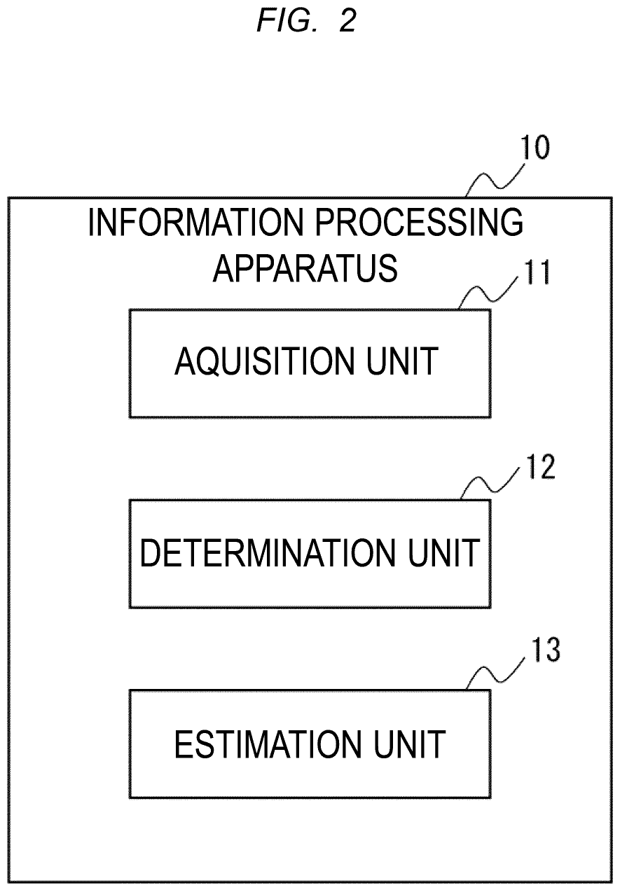

Referring to FIG. 2, the configuration of the information processing apparatus 10 according to the embodiment will be described. FIG. 2 is a diagram showing example of the configuration of the information processing apparatus 10 according to the embodiment. The information processing apparatus 10 has an acquisition unit 11, a determination unit 12 and an estimation unit 13. These units may be realized by the cooperation of one or more programs installed in the information processing apparatus 10 and the hardware of the information processing apparatus 10, such as processors and memory, etc.

The acquisition unit 11 acquires each image captured at each point in time by the shooting device 20 mounted on the moving object 1. The determination unit 12 determines the type of movement of the moving object 1 based on each image acquired by the acquisition unit 11.

The estimation unit 13 estimates the amount of movement and direction of movement of the moving object 1 from the first point in time when the first image was captured to the second point in time when the second image was captured, based on the first image and the second image captured at a time interval corresponding to the type of movement of the moving object 1.

### (Hardware Configuration)

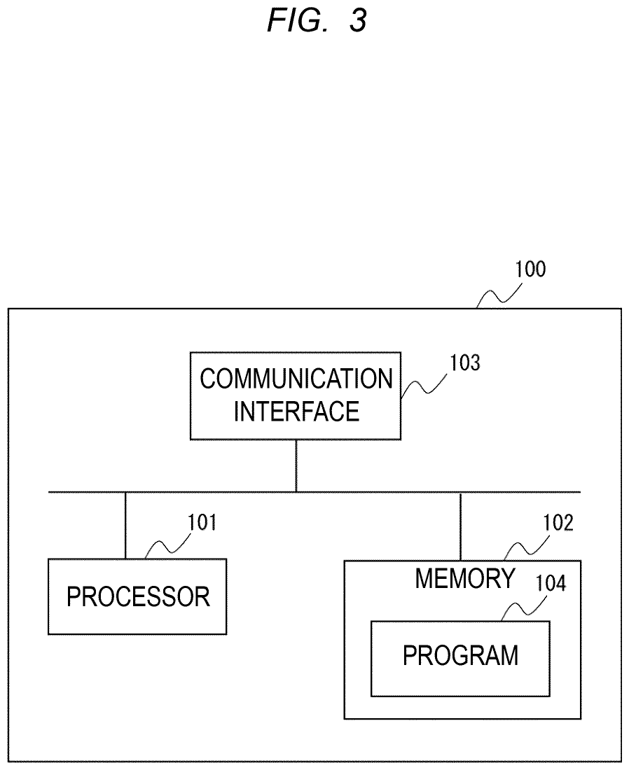

FIG. 3 is a block diagram showing an example of the hardware configuration of the information processing apparatus 10 according to the embodiment. In the example of FIG. 3, the information processing apparatus 10 includes a processor 101, a memory 102 and a communication interface 103. These may be connected by a bus. The memory 102 stores at least a part of program 104. The communication interface 103 includes an interface necessary for communication with other network elements.

When the program 104 is executed by the cooperation of the processor 101 and the memory 102, at least a part of the processing of the embodiments disclosed herein is performed by the information processing apparatus 10. The memory 102 may be of any type. The memory 102 may be, by way of non-limiting example, a non-transitory computer-readable storage medium. Furthermore, the memory 102 may be implemented using any appropriate data storage technology such as semiconductor-based memory devices, magnetic memory devices, optical memory devices, fixed memory, and removable memory. Although only one memory 102 is shown in the information processing apparatus 10, there may be several physically different memory modules in the information processing apparatus 10. The processor 101 may be of any type. The processor 101 may include one or more processors based on microprocessors, digital signal processors (DSP), and, by way of non-limiting example, multicore processor architectures.

When loaded into a computer, the program includes a group of instructions (or software code) for causing the computer to perform one or more functions described in the embodiments. The program may be stored on a non-transitory computer-readable medium or a tangible storage medium. By way of example and not limitation, the computer-readable medium or tangible storage medium may include random-access memory (RAM), read-only memory (ROM), flash memory, solid-state drive (SSD) or other memory technologies, CD-ROM, digital versatile disc (DVD), Blu-ray® disc or other optical disc storage, magnetic cassette, magnetic tape, magnetic disk storage or other magnetic storage devices. The program may be transmitted on a transitory computer-readable medium or communication medium. By way of example and not limitation, the transitory computer-readable medium or communication medium may include electrical, optical, acoustical, or other forms of propagated signals.

### (Processing Flow)

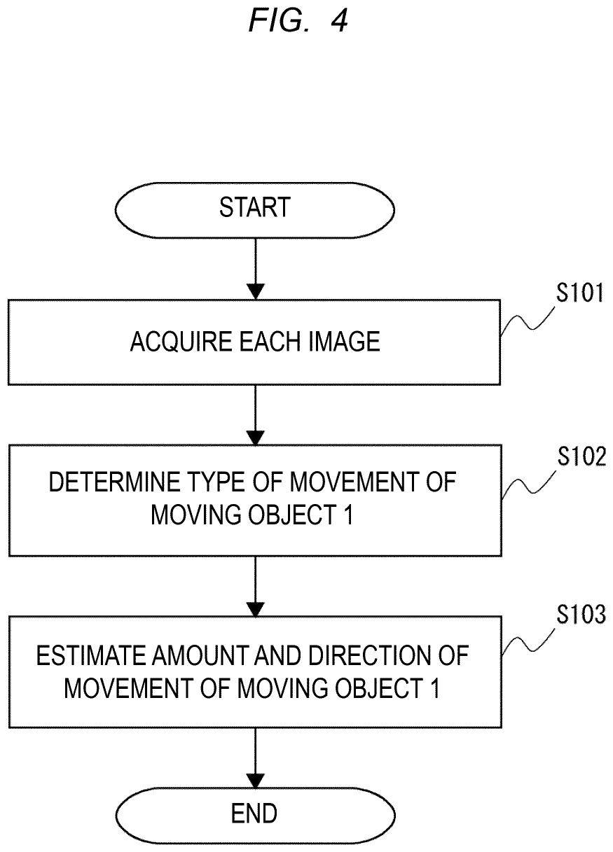

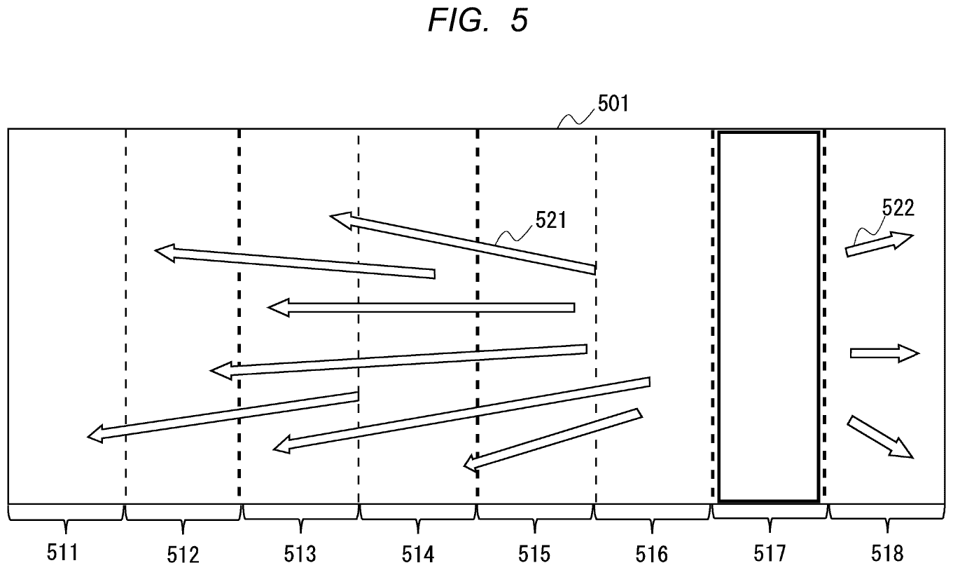

Referring to FIGS. 4 and 5, an example of processing in the information processing apparatus 10 according to the embodiment will be described. FIG. 4 is a flowchart showing an example of processing in the information processing apparatus 10 according to the embodiment. FIG. 5 is a diagram showing an example of optical flow according to the embodiment.

At step S101, the acquisition unit 11 acquires each image captured at each point in time by the shooting device 20 mounted on the moving object 1. Here, the acquisition unit 11 may acquire each image captured at a specific frame rate (for example, 60 fps (frames per second)).

Subsequently, the determination unit 12 determines the type of movement of the moving object 1 based on each image acquired by the acquisition unit 11 (in step S102). Here, the type of movement of the moving object 1 may indicate at least one of the moving speeds of the moving object 1, the curvature of the moving direction of the moving object 1, and the change in the gradient of the moving direction of the moving object 1. For example, the curvature of the moving direction may indicate information about the degree of turning to the right or left when the moving object 1 is traveling on a curve in a road or the like. The curvature may be the reciprocal of the radius of curvature. The radius of curvature may be the radius of the circle when the curve is locally considered as an arc of a circle. The larger the radius of curvature, the gentler the curve. Therefore, the tighter the curve, the greater the curvature.

The change in the gradient of the direction of movement may be information indicating the degree of change in the inclination upwards or downwards when the moving object 1 is traveling on an uphill or downhill slope.

The determination unit 12 may calculate the optical flow based on two images taken at a specific time interval (for example, 1/60 second) and may determine the type of movement based on the optical flow. In this case, the determination unit 12 may determine the type of movement based on the magnitude and direction of each vector (flow vector) included in the calculated optical flow. Optical flow is a vector indicating the movement of an object, calculated based on an image taken at a certain point in time and another image taken at a later point in time. The determination unit 12 may calculate the optical flow using a gradient method, which is a technique for estimating flow vectors from conditions based on the spatiotemporal differential equation of images. Furthermore, the determination unit 12 may calculate the optical flow using a block matching method, which is a technique that divides the image of the previous frame into regions of a specific size, searches within the image of the next frame, and detects the region with the highest similarity to the region of interest in the previous frame.

The determination unit 12 may determine that the curvature of the direction of movement of the moving object 1 is greater (the curve is tighter) the more the position where the horizontal component of each flow vector changes is shifted to the left or right from the center of the image (the direction of travel of the moving object 1).

In the example of FIG. 5, in the image 501, each flow 521, etc., on the left side of the region 517 is directed to the left, and each flow 522, etc., on the right side of the region 517 is directed to the right. Also, the region 517 where the horizontal component of each flow vector changes is located somewhat to the right of the center of the image 501. In this case, the determination unit 12 may determine the type of movement of the moving object 1 as a “gentle curve.”

In this case, the determination unit 12 may divide the image 501 into eight equally wide horizontal regions 511 to 518. The determination unit 12 may search for the position (region) where the horizontal component of each flow vector switches between positive and negative in each region 511 to 518. In this case, the determination unit 12 may calculate the average value of the horizontal component of each flow vector in each region 511 to 518. Then, the determination unit 12 may determine the region where the average value of the horizontal component of each flow vector in each region 511 to 518 switches between positive and negative.

Furthermore, the determination unit 12 may determine it as “stop” if the average value of the magnitude (length) of each flow vector is less than a threshold. Also, the determination unit 12 may determine it as a “sharp curve” if the horizontal component of all flow vectors is in the same direction. Moreover, the determination unit 12 may determine it as “straight ahead” if the position where the horizontal component of each flow vector changes is near the center of the image. Furthermore, the determination unit 12 may determine that the change in the gradient of the direction of movement of the moving object 1 is greater the more the position where the vertical component of each flow vector changes is shifted up or down from the center of the image.

### Example 1 of Determining the Type of Movement of the Moving Object

As example 1, the determination unit 12 may determine the type of movement of the moving object 1 based on machine learning. In this case, the determination unit 12 may use, for example, a CNN (Convolutional Neural Network), DNN (Deep Neural Network), Transformer, or SVM (Support Vector Machine) to determine (infer) the type of movement of the moving object 1 according to each vector contained in the optical flow.

### Example 2 of Determining the Type of Movement of the Moving Object

As example 2, the determination unit 12 may determine the type of movement of the moving object 1 based on a model of optical flow registered in advance for each type of movement. In this case, the determination unit 12 may determine the type of movement of the moving object 1 based on the similarity between each vector contained in each model and each vector contained in the calculated optical flow. In this case, the determination unit 12 may determine the type of movement of the moving object 1 as the type of movement of the model with the highest similarity to the calculated optical flow.

### Example 3 of Determining the Type of Movement of the Moving Object

As example 3, the determination unit 12 may determine the type of movement of the moving object 1 based on, for example, an acceleration sensor mounted on the moving object 1, or operation information such as the handle obtained from the ECU of the moving object 1.

Subsequently, the estimation unit 13 specifies the time interval between the shooting times of two images for estimating the amount and direction of movement of the moving object 1 based on the type of movement of the moving object 1 (Step S103). Here, the estimation unit 13 may, for example, decide on a longer time interval the smaller the curvature of the moving direction of the moving object 1 (the gentler the curve). In this case, the estimation unit 13 may set the time interval as the first-time interval (for example, 1/60 seconds) in the case of the aforementioned “sharp curve”, and a second time interval longer than the first-time interval (for example, 1/10 seconds) in the case of the aforementioned “gentle curve”.

In the case of calculating optical flow, it may be detected that flow vectors unrelated to the movement of the moving object 1 due to the movement of an object or mismatching, among others. When the magnitude of each calculated flow vector is relatively large, it becomes relatively easy to remove flow vectors unrelated to the movement of the moving object 1 as noise. This is because, for example, flow vectors unrelated to the movement of the moving object 1 are relatively clearly different in size and direction compared to other flow vectors nearby in the image.

When the moving object 1 is moving, by deciding on a longer time interval, it is possible to make the magnitude of each calculated flow vector relatively large. Therefore, it becomes relatively easy to remove flow vectors unrelated to the movement of the moving object 1 as noise. Accordingly, it is possible to appropriately estimate the amount of movement and the direction of movement of the moving object.

Furthermore, the estimation unit 13 may decide on a longer time interval, for example, the slower the moving speed of the moving object 1. By doing so, similarly, it becomes relatively easy to remove flow vectors unrelated to the movement of the moving object 1 as noise. Accordingly, it is possible to appropriately estimate the amount of movement and the direction of movement of the moving object.

Furthermore, the estimation unit 13 may decide on a longer time interval, for example, the smaller the change in the gradient of the moving direction of the moving object 1. By doing so, similarly, it becomes relatively easy to remove flow vectors unrelated to the movement of the moving object 1 as noise. Accordingly, it is possible to appropriately estimate the amount of movement and the direction of movement of the moving object.

Subsequently, the estimation unit 13 estimates the amount of movement and the direction of movement of the moving object 1 from the first point in time when the first image was captured to the second point in time when the second image was captured based on the first image and the second image captured at the time interval (in step S104). By doing so, for example, it is possible to estimate the position of the moving object 1 after movement. The estimation unit 13 may output the estimation results to an ECU for autonomous driving, among others. By doing so, for example, it is possible to implement Visual SLAM (Simultaneous Localization and Mapping) that creates an environmental map and performs self-position estimation on the environmental map by sensing the surroundings while the moving object 1 is traveling.

Here, the acquisition unit 11 may acquire each image captured by the shooting device 20 at a specific frame rate. And the estimation unit 13 may extract the first image and the second image from the images acquired by the acquisition unit 11. By doing so, while keeping the frame rate of shooting by the shooting device 20 constant, it is possible to estimate the position of the moving object 1 after movement, among others.

In the case of realizing autonomous driving or driving assistance of a moving object, adding sensors other than cameras increases the cost of the system. Also, the complexity of processing increases, leading to an increase in the amount of software development and also an increase in processing delay in the data pipeline. On the other hand, according to this disclosure, it is possible to appropriately estimate the amount of movement and the direction of movement of the moving object without using sensors other than cameras.

### Modified Embodiment

The information processing apparatus 10 may be a device contained within a single housing, but the information processing apparatus 10 of the present disclosure is not limited to this. Each part of the information processing apparatus 10 may be realized by cloud computing constituted by one or more computers, for example. Furthermore, the information processing apparatus 10 and the shooting device 20 may be housed within the same housing and configured as an integrated information processing apparatus. Moreover, at least a part of the processing of each functional part of the information processing apparatus 10 may be executed by the shooting device 20. Such information processing apparatus 10 are also included as examples of the “information processing apparatus” of the present disclosure.

As described above, the present disclosure has been described with reference to embodiments, but the present disclosure is not limited to the described embodiments. Various changes can be made to the configuration and details of the present disclosure within the scope of the present disclosure as understood by those skilled in the art. And each embodiment can be appropriately combined with other embodiments.

What is claimed is:

1. An information processing apparatus comprising:
an acquisition unit for acquiring each image captured at each point in time by a capturing device mounted on a moving object; a determination unit for determining the type of movement of the moving object based on each of the images; and
an estimation unit for estimating the amount and direction of movement of the moving object from a first point in time when a first image was captured to a second point in time when a second image was captured based on the first image and the second image captured at a time interval corresponding to the type of movement from the first image.

2. The information processing apparatus according to claim 1,
wherein the type of movement includes at least one of the moving speeds of the moving object, the curvature of the moving direction of the moving object, and the change in gradient of the moving direction of the moving object.

3. The information processing apparatus according to claim 1,
wherein the estimation unit determines the time interval longer as the moving speed of the moving object is slower.

4. The information processing apparatus according to claim 1,
wherein the estimation unit determines the time interval longer as the curvature of the moving direction of the moving object is smaller.

5. The information processing apparatus according to claim 1,
wherein the estimation unit determines the time interval longer as the change in gradient of the moving direction of the moving object is smaller.

6. The information processing apparatus according to claim 1,
wherein the determination unit calculates optical flow based on each of the images and determines the type of movement based on the optical flow.

7. The information processing apparatus according to claim 1,
wherein the acquisition unit acquires each of the images captured by the capturing device at a specific frame rate, and the estimation unit extracts the first image and the second image from the images.

8. An information processing method performs by an information processing apparatus includes:
acquiring each image captured at each point in time by a capturing device mounted on a moving object;
determining the type of movement of the moving object based on each of the images; and
estimating the amount and direction of movement of the moving object from a first point in time when a first image was captured to a second point in time when a second image was captured based on the first image and the second image captured at a time interval corresponding to the type of movement from the first image.

9. A program for causing a computer to execute the process of acquiring each image captured at each point in time by a capturing device mounted on a moving object, determining the type of movement of the moving object based on each of the images, and estimating the amount and direction of movement of the moving object from a first point in time when a first image was captured to a second point in time when a second image was captured based on the first image and the second image captured at a time interval corresponding to the type of movement from the first image.
